(19) United States
(12) Patent Application Publication
(10) Pub. No.: US 2009/0057953 A1
(43) Pub. Date: Mar. 5, 2009

(54) Extrusion blow molding machine

(76) Inventor: James Vassar, West Chicago, IL (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/895,936

(22) Filed: Aug. 28, 2007

(51) Int. Cl. B29D 22/00

(52) U.S. Cl. 264/297.8; 425/538

(57) ABSTRACT

An extrusion blow molding machine has a first and a second row of multiple extruded parisons. The device further includes a mold having a first molding block section having a first plurality of cavity portions, a second molding block section having a second plurality of cavity portions and a third molding block section. The third molding block section includes a third plurality of cavity portions that are alignable one each with the cavity portions in the first plurality of cavity portions to thereby define a first row of cavities. The third molding block section also includes a fourth plurality of cavity portions that are alignable one each with the cavity portions in the second plurality of cavity portions to thereby define a second row of cavities.

### TECHNICAL FIELD OF THE INVENTION

This invention pertains to extrusion blow molding, and in more particular applications, to extrusion blow molding multiple rows of extruded parisons.

### BACKGROUND OF THE INVENTION

Blow molding is a process whereby hollow plastic parts, such as drink bottles and other containers, are formed. One form of blow molding, extrusion blow molding, is performed whereby plastic materials are melted and extruded into a hollow tube known as a parison. The parison is then positioned within a mold, which is generally metal and may be cooled. Once located within the mold, a fluid, such as air, is blown into the parison, inflating it to conform to the shape of the mold. After the molded part is sufficiently cool, the mold is opened and the part removed.

Generally, there are two main categories of extrusion blow molding forms; continuous extrusion and intermittent extrusion. Continuous extrusion processes include shuttle-type machines and rotary wheel machines. Intermittent extrusion processes include reciprocating screw machines and accumulator head machines.

These extrusion blow molding processes can be practiced to extrude and form single and multiple extruded parisons. However, when multiple parisons are extruded and formed at the same time, they are extruded and formed in a single row.

Furthermore, conventional extrusion blow molding machines are generally very large and require significant floor space. Oftentimes, to increase product output, a manufacturer will have to increase the number of parisons by adding additional parisons in the existing single row and/or adding a second extrusion blow molding machine. However, manufacturers are reluctant to increase the size of the machines and/or add additional machines because of space constraints.

### SUMMARY OF THE INVENTION

In one form, an extrusion blow mold is provided. The blow mold includes a first molding block section having a first plurality of cavity portions, a second molding block section having a second plurality of cavity portions, and a third molding block section located between the first and second molding block sections. The third molding block section includes a third plurality of cavity portions that are alignable, one each with the cavity portions in the first plurality of cavity portions, to thereby define a first plurality of cavities, each to receive a parison. The third molding block section also includes a fourth plurality of cavity portions that are alignable, one each with the cavity portions in the second plurality of cavity portions, to thereby define a second plurality of cavities, each to receive a parison.

In another form, the blow molding machine includes a first row of openings, a second row of openings, a mold, a first row of blow pins and a second row of blow pins. The first row of openings is suitable for extruding a first row of multiple parisons. The second row of openings is suitable for extruding a second row of multiple parisons. The mold has a length and includes a first row of cavities extending along the length and a second row of cavities extending along the length, adjacent the first row of cavities.

The first row of blow pins cooperates with the first row of cavities to force the first row of parisons outwardly within the mold. The second row of blow pins cooperates with the second row of cavities to force the second row of parisons outwardly within the mold.

In one form, a method for producing multiple rows of extruded blow molded products is provided. The method includes the steps of: extruding a first and a second row of multiple parisons; directing the first row of multiple parisons within a first row of mold cavities extending along a length in a mold; directing the second row of multiple parisons within a second row of mold cavities extending along the length in the mold adjacent the first row of cavities; blowing a pressurized fluid within the first and second rows of multiple parisons to force the parisons outwardly within the first and second rows of mold cavities to form first and second rows of molded products; and releasing the first and second rows of molded products from the first and second rows of mold cavities.

According to one form, the first and third plurality of cavity portions are mirror images of one another and the second and fourth plurality of cavity portions are mirror images of one another.

In one form, the third molding block section is secured in a fixed position while the first and second molding block sections are permitted to move towards and away from the third molding block section.

According to one form, the extrusion blow mold includes a rack and gear device having a rotating gear located on one of the molding block sections and a first toothed rack extending from another of the molding block sections and operably coupled to the rotating gear.

In one form, the extrusion blow mold includes a second toothed rack extending from a remaining molding block section and operably coupled to the rotating gear such that when the rotating gear rotates, the first and second molding block sections are brought towards or away from the third molding block section.

According to one form, the extrusion blow mold further includes a helical gear device having a first nut secured to one of the molding block sections, a bearing secured to another of the molding block sections and a helical gear extending between the first nut and the bearing.

In one form, the extrusion blow mold further includes a second nut secured to a remaining molding block section wherein the helical gear extends between the first and second nuts through the bearing such that when the helical gear rotates, the first and second molding block sections are brought towards or away from the third molding block section.

According to one form, the extrusion blow mold includes an harmonic arm device having a first arm secured to one of the molding block sections and a second arm secured to another of the molding block sections.

In one form, the extrusion blow mold includes a third arm secured to a remaining molding block section wherein the third arm is secured at a first end to the first arm and secured at a second end to the second arm such that as the third arm pivots, the first and second molding block sections are brought towards or away from the third molding block section.

In one form, the third molding block section has first and second mold plates, and the extrusion blow mold is changeable between the open and closed states by moving at least a part of the first molding block section and the first mold plate as a unit relative to the second molding block section and the second mold plate.

Other objects, features, and advantages of the invention will become apparent from a review of the entire specification, including the appended claims and drawings.

### BRIEF DESCRIPTION OF THE DRAWINGS

FIG. 1 is a block diagram of an extrusion blow molding machine;

FIG. 2 is a block diagram of an alternative embodiment of an extrusion blow molding machine;

FIG. 3 is a top view of an extrusion blow mold in an open state;

FIG. 4 is a top view of the extrusion blow mold of FIG. 3 in a closed state;

FIG. 5 is a top view of another extrusion blow mold in an open state;

FIG. 6 is a side view of the extrusion blow mold of FIG. 5;

FIG. 7 is a side view of one molding block section of the extrusion blow mold of FIG. 5;

FIG. 8 is a side view of an extrusion blow mold including a rack and gear device;

FIG. 9 is a side view of an extrusion blow mold including a helical gear device;

FIG. 10 is a side view of an extrusion blow mold including an harmonic arm device;

FIG. 11 is a schematic representation of a further modified form of extrusion blow mold in an open state;

FIG. 12 is a view as in FIG. 11 with the extrusion blow mold in a closed state; and

FIG. 13 is a schematic representation of an extrusion blow mold.

### DETAILED DESCRIPTION OF THE ILLUSTRATED EMBODIMENT

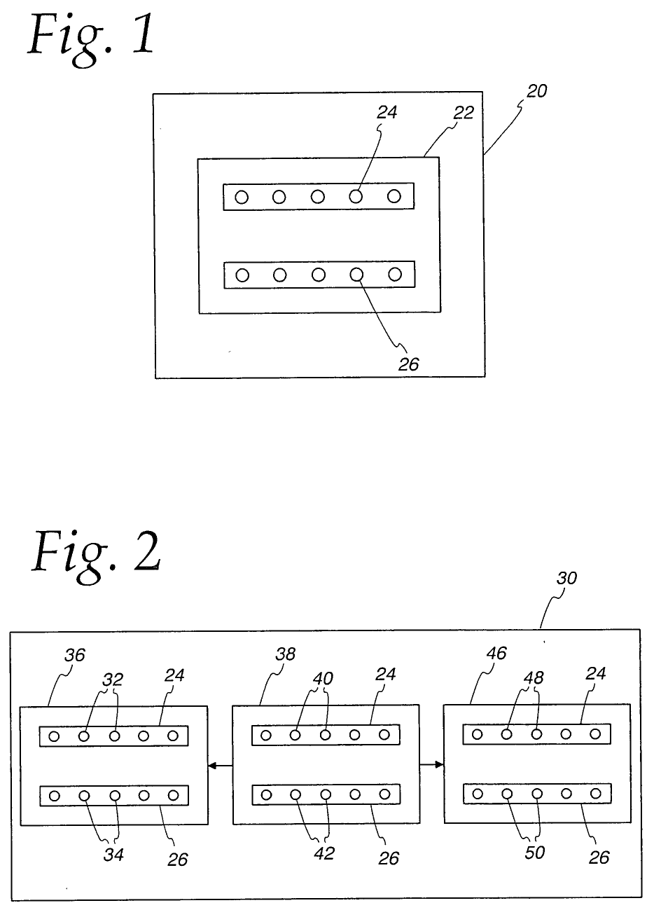

In FIG. 1, an intermittent extrusion blow molding machine, such as an accumulator-type extrusion blow molding machine 20, is shown. As understood by those skilled in the art, with this form of extrusion blow molding machine, extrusion and blow molding steps are performed at a common location, such as at a station 22. The station 22 includes a first row and a second row of parisons 24,26 which are extruded and then formed using a mold and blow pins (not shown).

An alternative type of extrusion blow molding machine is illustrated in FIG. 2. FIG. 2 depicts a continuous extrusion machine, such as a shuttle-type extrusion blow molding machine 30. In this form, the first row of parisons 24 is extruded through a first row of openings 32 and the second row of parisons 26 is extruded through a second row of openings 34 at an extrusion station 36. A mold 38 shuttles to the extrusion station 36 and receives the first row of parisons 24 in a first row of cavities 40 and receives the second row of parisons 26 in a second row of cavities 42. The mold 38 then shuttles from the extrusion station 36 to a blow pin station 46. At the blow pin station 46, a first row of blow pins 48 will be inserted into the first row of parisons 24 in the first row of mold cavities 40. Similarly, a second row of blow pins 50 will be inserted into the second row of parisons 26 in the second row of mold cavities 42. Each of the blow pins in the first and second rows of blow pins 48,50 cooperates with the first and second mold cavities 40,42 whereby a fluid is blown therefrom into each of the parisons, forcing the parisons outwardly to conform to the shape of the respective blow mold cavities, as understood by those skilled in the art.

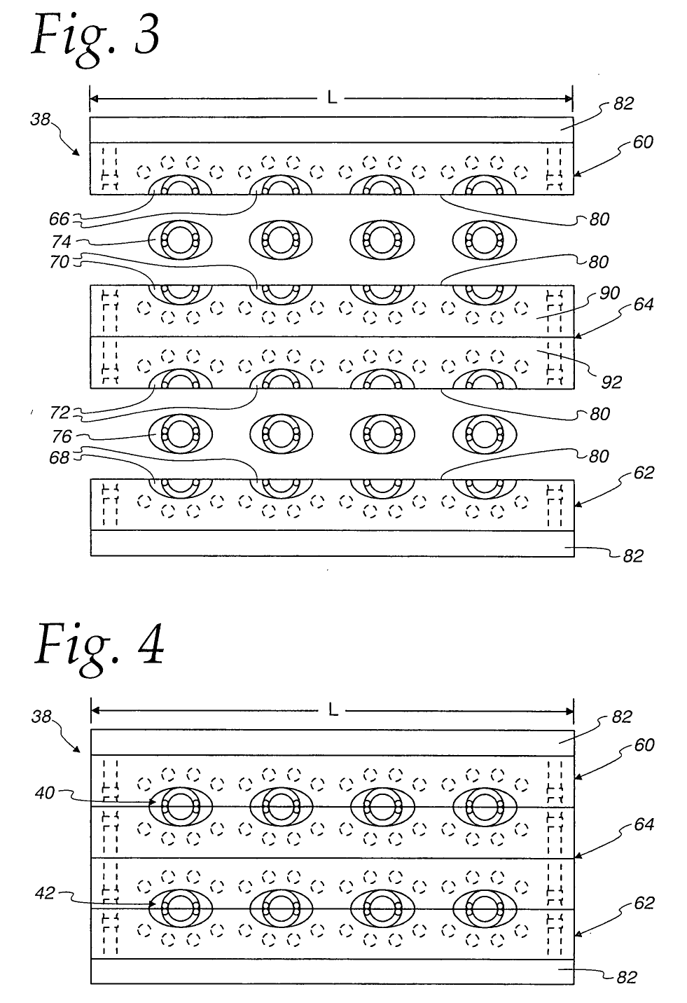

One exemplary form of the mold 38 will now be discussed in more detail. It should be understood that the mold 38 is suitable for use in both types of extrusion blow molding machines 20,30. Furthermore, the mold 38 may be utilized in other forms of extrusion blow molding machines as understood by those skilled in the art. The mold 38 is illustrated in FIG. 3 in an open state. In this embodiment, the mold 38 includes a first molding block section 60, a second molding block section 62 and a third molding block section 64. It should be understood that the molding block sections 60,62,64, and therefore the resulting mold 38, may take a variety of shapes. In one form the molding block sections are generally rectangular and/or cylindrical extending along a length L and have a variety of cross-sectional shapes. The cross-sectional shapes of the molding block sections 60,62,64 include, but are not limited to squares, rectangles, circles and the like.

The first molding block section 60 includes a first plurality of cavity portions 66. Similarly, the second molding block section 62 includes a second plurality of cavity portions 68. The third molding block section 64 includes a third plurality of cavity sections 70 and a fourth plurality of cavity sections 72.

As illustrated in FIG. 4, the mold 38 of FIG. 3 is in a closed state. When in the closed state, the cavity portions 70 are alignable one each with the first plurality of cavity portions 66 to define the first row of cavities 40 extending along the length L. Similarly, when in the closed position, the cavity portions 72 are alignable one each with the second plurality of cavity portions to define the second row of cavities 42 extending along the length L, adjacent the first row 40. As shown in FIG. 3, after the parisons are molded, the mold 38 is placed again in the open state whereby a first row of molded products 74 and a second row of molded products 76 can be released from the mold 38.

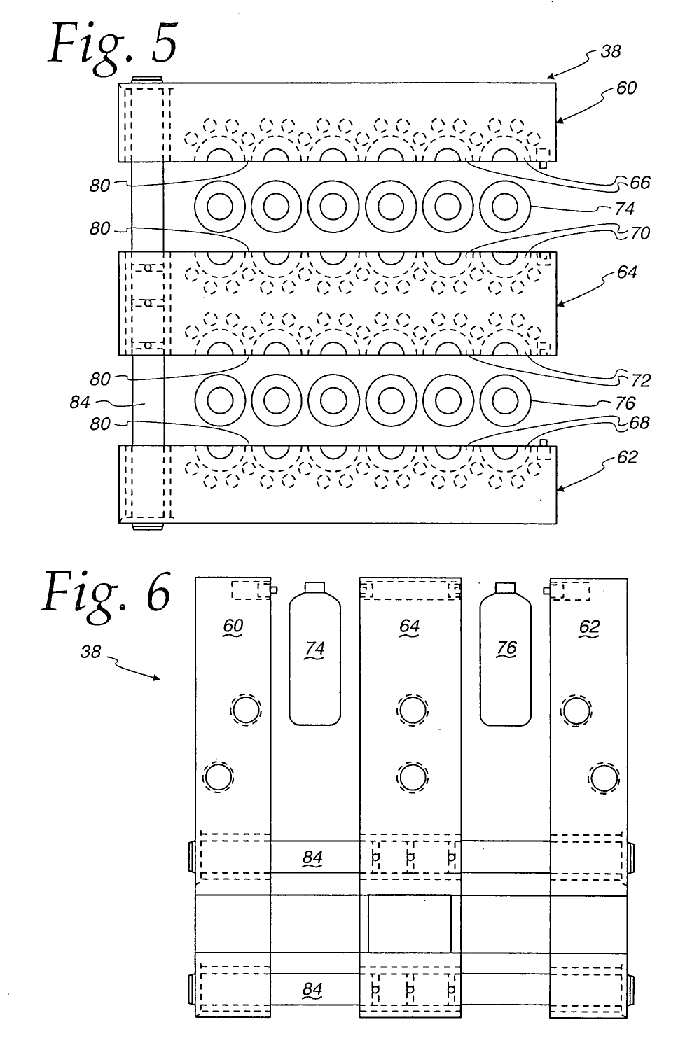

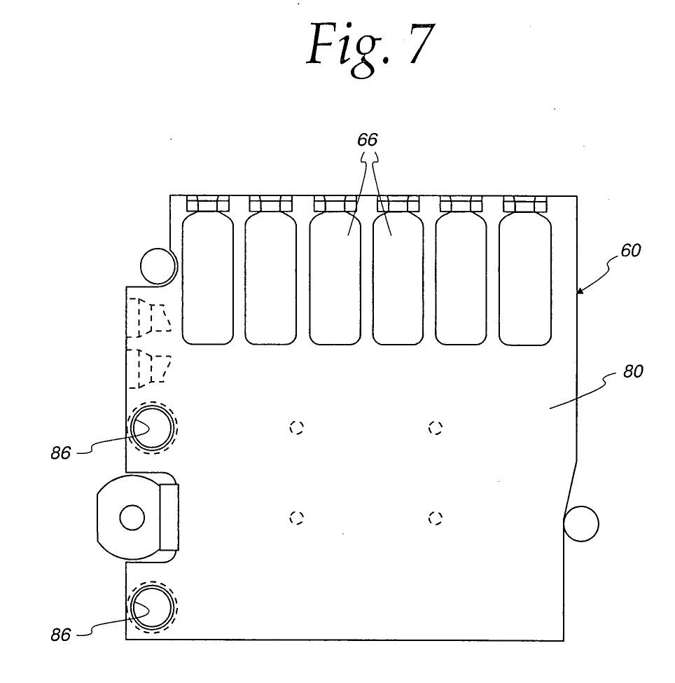

The respective rows of cavities 40,42 and cavity portions 66,68,70,72 may take a variety of shapes and forms. For example, as shown in FIGS. 3-4, the shapes are generally oval-shaped cylinders. In another example, as shown in FIGS. 5-7, the shapes are generally circular-shaped cylinders. It should be understood that the cavities 40,42 and cavity portions 66,68,70,72 may take a wide variety of shapes and orientations to produce a variety of molded products 74,76.

Furthermore, in one form, the respective pairs of cavity portions 66,70 and 68,72 are substantially mirror images of one another. However, it should be understood by those skilled in the art that the pairs cavity portions 66,70 and 68,72 need not be mirror images so that products of varying shapes and dimensions may be produced.

Analogously, in one form, the respective cavity portions 66,68,70,72 each makes up approximately half of the respective cavities 40,42. However, it should be understood by those skilled in the art that each of the cavity portions 66,68,70,72 may make up a different portion of each of the overall cavities 40,42. For example, the cavity portion 66 may form sixty-five percent of the overall cavity 40 while the cavity portion 70 forms thirty-five percent of the overall cavity 40. Therefore, the sizes and orientations of the molding block sections 60,62,64 may be adjusted as desired to accommodate the cavity portions 66,68,70,72.

As seen in FIGS. 3-7, each of the molding block sections 60,62,64 has at least one substantially flat face 80. In this regard, each of the faces 80 on the molding block sections 60,62,64 will contact the face 80 of the corresponding molding block section such that the faces 80 will appropriately seal the cavities 40,42 to form the products 74,76. However, it should be understood that the molding block sections 60,62,64 as well as the faces 80 may take a variety of shapes. For example, the molding block section 64 may take a circular shape and therefore, the faces 80 of the molding block sections 60,62 will have an arced shape to correspond to the circular shape. Other shapes for the molding block sections 60,62,64 and faces 80 are also contemplated as understood by those skilled in the art.

The mold 38 may also include additional features, such as platens 82, as seen in FIGS. 3-4. The platens 82 are located adjacent the molding block sections 60,62 to help retain the molding block sections 60,62 in the appropriate position as well as add rigidity to the mold 38. Furthermore, the platens 82 may be cooled and/or heated as desired to help cool and/or heat the mold 38 during the blow molding process.

Additionally, the mold 38 may include one or more guide rods 84, as illustrated in FIGS. 5-7, wherein the mold 38 is slightly modified from the form of the mold 38 in FIGS. 3 and 4, primarily by reason of the product shape that each is designed to form. The rods 84 pass through openings 86 in one or more of the molding block sections 60,62,64. The rods 84 can be used to help guide the molding block sections 60,62,64 as the mold 38 changes between the open and closed states. Furthermore, the rods 84 help maintain the molding block sections 60,62,64 in the desired orientations.

Furthermore, the third molding block section 64 may include multiple mold plates 90,92 that are secured to one another, as shown in FIGS. 3-4. In this form, either of the plates 90,92 is removable such that a new plate having the same or different sized/shaped cavity portions 70 or 72 may be inserted thereby permitting a different sized/shaped cavity 40 or 42 to be interchanged without modifying other of the cavities 40,42. In this regard, wear plates (not shown) may also be used in the mold 38 as understood by those skilled in the art.

As described above, the molding block sections 60,62,64 are movable relative to one another to substantially enclose the cavities 40,42 and mold the parisons. There are a variety of means available to provide movement for the molding block sections 60,62,64. In one form, the third molding block section 64 is held in place by a securing device (shown schematically) while the first and second molding block sections 60,62 are moved towards the third molding block section 64. In another form, the third molding block section 64 is not held by the securing device, but is still maintained in substantially the same position as a result of the respective movements of the first and second molding block sections 60,62. However, it should be understood that the third molding block section 64 need not be held in place or remain in the same position.

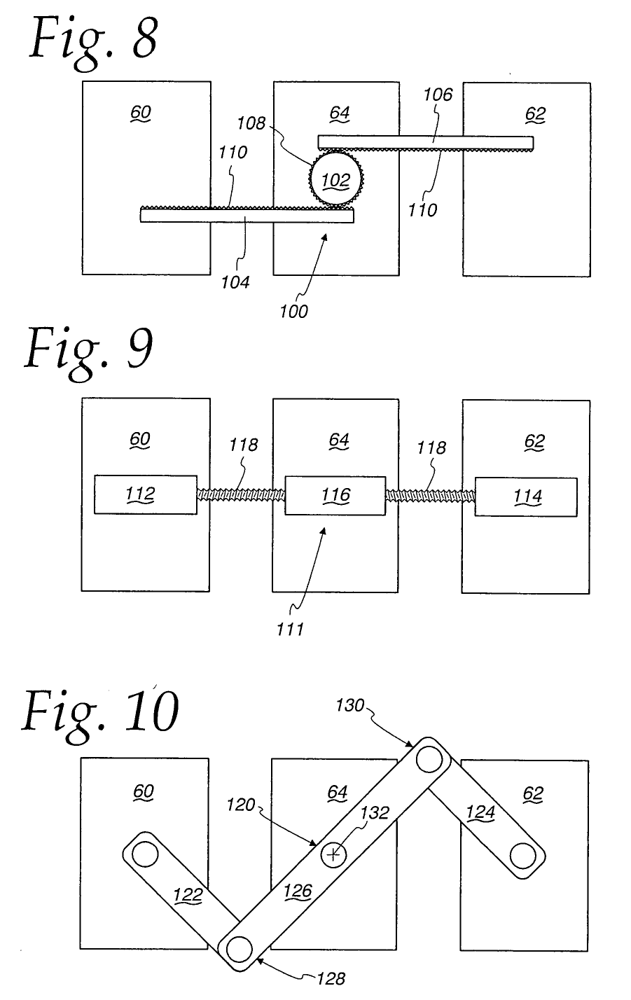

As shown in FIG. 8, a rack and gear device 100 is included to relatively move the molding block sections 60,62,64. The rack and gear device 100 includes a rotating gear 102 located on the third molding block section 64. The rack and gear device 100 also includes a first toothed rack 104 extending from the first molding block section 60 and operably coupled to the rotating gear 102. The rack and gear device 100 further includes a second toothed rack 106 extending from the second molding block section 62 and operably coupled to the rotating gear 102. The first and second toothed racks 104,106 are secured to the respective molding block sections 60,62 in any conventional manner, such as by using bolts. The rotating gear 102 includes teeth 108 which cooperate with teeth 110 on the first and second toothed racks 104,106 such that when the rotating gear 102 rotates, the first and second molding block sections 60,62 are brought towards or away from the third molding block section 64 depending on the direction of rotation of the gear 102. It should be understood that the rotating gear 102 and the first and second toothed racks 104,106 may be located on any of the molding block sections 60,62,64 and/or may include multiple rack and gear devices 100. The rotating gear 102 may be powered by electric motors, hydraulics and other forms understood by those skilled in the art.

As shown in FIG. 9, a helical gear device 111 is included to relatively move the molding block sections 60,62,64. The helical gear device 110 includes a first nut 112 secured to the first molding block section 60 and a second nut 114 secured to the second molding block section 62. The helical gear device 110 further includes a bearing 116 secured to the third molding block section 64 and a helical gear 118 extending between the first and second nuts 112,114 through the bearing 116. The helical gear 118 can be rotated, such as at the bearing 116, which will cause the first and second molding block sections 60,62 to move towards or away from the third molding block section 64 depending on the direction of rotation of the helical gear 118. It should be understood that the first and second nuts 1 12,114 and the bearing 1 16 may be located on any of the molding block sections 60,62,64 and/or may include multiple helical gear devices 110. The helical gear 118 may be powered by electric motors, hydraulics and other forms understood by those skilled in the art.

As shown in FIG. 10, an harmonic arm device 120 is included to relatively move the molding block sections 60,62,64. The harmonic arm device 120 includes a first arm 122 secured to the first molding block section 60, a second arm 124 secured to the second molding block section 62 and a third arm secured 126 secured to the third molding block section 64. The third arm 126 is secured at a first end 128 to the first arm 122 and secured at a second end 130 to the second arm 124. The third arm 126 is permitted to pivot about a pivot axis 132 such that as the third arm 126 pivots, the first and second molding block sections 60,62 move towards or away from the third molding block section 64 depending on the direction the third arm 126 pivots. It should be understood that the harmonic arm device 120 may also be configured to move only one molding block section 60,62,64 relative to another molding block section 60,62,64 such as through the use of multiple harmonic arm devices 120 and/or through an alternative configuration of the arms 122,124,126. The harmonic arm device 120 may be powered by electric motors, hydraulics and other forms understood by those skilled in the art.

It should be understood that other additional features may also be included as understood by those skilled in the art. For example, the mold may include mold release devices, takeout arms, conveyors and the like, as used in conventional extrusion blow molding machines. Furthermore, it should be understood that many existing single row extrusion machines may be retrofit with the mold 38 as described herein.

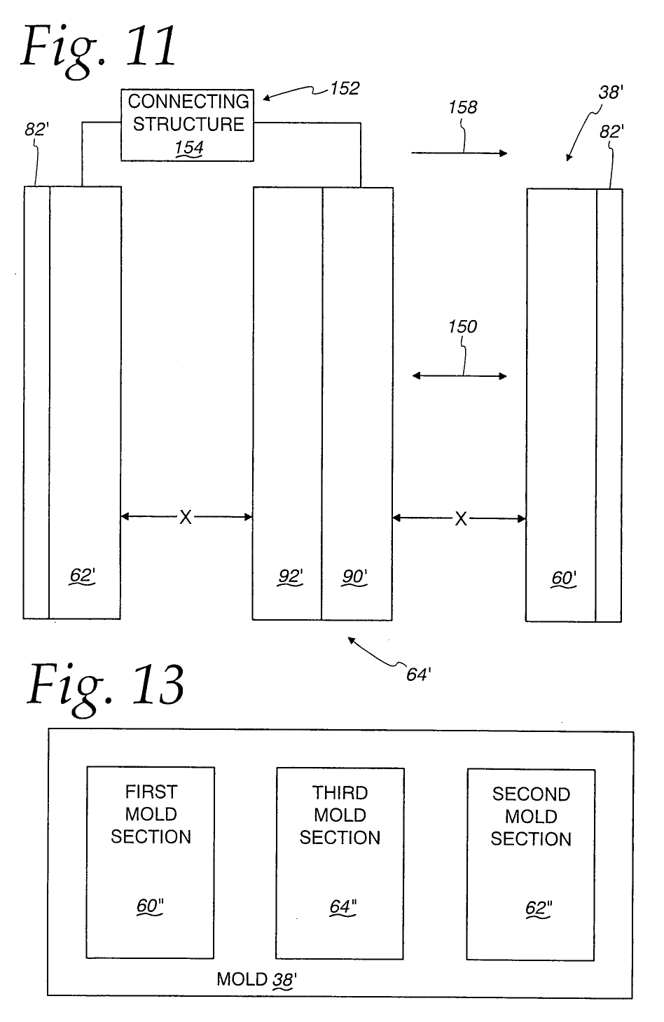

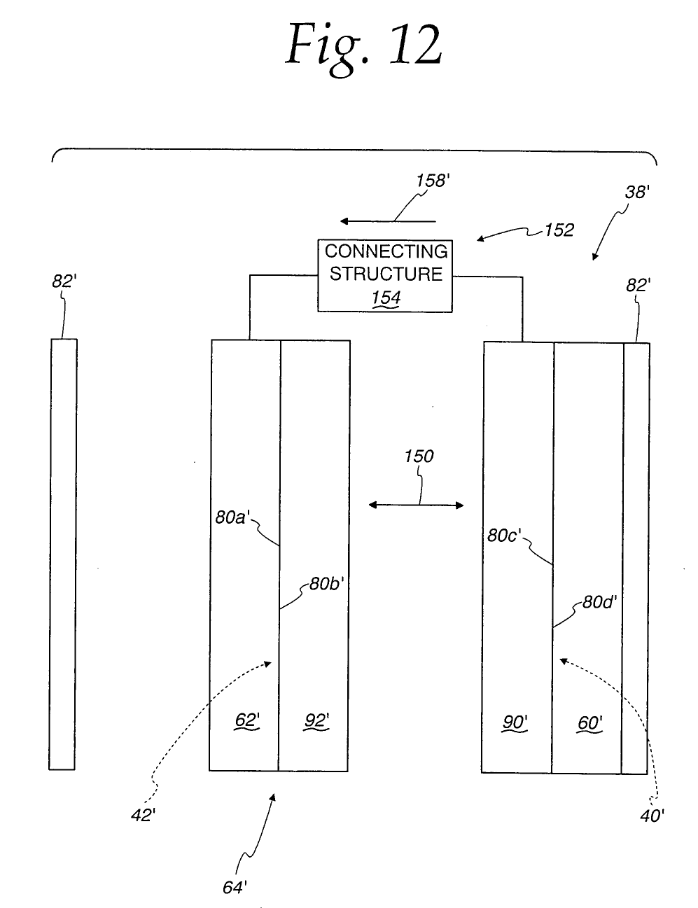

In FIGS. 11 and 12, a modified form of mold is shown schematically at 38′, incorporating the same basic components for the mold 38, and with corresponding components identified with the same reference numeral and a “′” designation. That is, the mold 38′ has mold plates 90′, 92′, corresponding to the mold plates 90, 92 making up the molding block section 64 on the mold 38. The mold plates 90′, 92′ together make up a corresponding molding block section 64′. Whereas the mold plates 90′, 92′ are at all times maintained together in abutting relationship on the mold 38, on the mold 38′, the mold plate 90′ is movable towards and away from the mold plate 92′ along an operating line, indicated by the double-headed arrow 150, as the mold cavities 40′, 42′ are opened and closed. Additionally, whereas the mold section 62 is at all times maintained together in abutting relationship with the associated platen 82 on the mold 38, the mold section 62′ is movable towards and away from its associated platen 82′ along the operating line, as the mold cavities are opened and closed.

More specifically, the molding block section 62′ and mold plate 90′ are maintained to move together as a unit 152, along the operating line, by a connecting structure 154, that may take virtually an unlimited number of different forms, as understood by those skilled in this art. The unit 152 is movable along the operating line relative to the platens 82′, mold plate 92′, and molding block section 60′, that maintain the same fixed relationship as the mold 38′ changes between the different states in FIGS. 11 and 12.

In the open mold state of FIG. 11, the molding block sections 60′, 62′ are abutted to their respective platens 82′, and the mold plates 90′, 92′ are abutted together. The actual abutting relationship of the above parts is not a requirement, however. The molding block section 62′ and the mold plate 92′, that have portions that combine to cooperatively define the mold cavities 42′, are in spaced relationship along the operating line, as are the molding block section 60′ and mold plate 90′ that have portions that combine to cooperatively define the mold cavities 40′. In the open mold state of FIG. 11, the spacing between the molding block section 60′ and mold plate 90′ is the same as the spacing between the molding block section 62′ and the mold plate 92′, as indicated by the dimension X.

To change the mold 38′ from the open state of FIG. 11 to the closed state of FIG. 12, the unit 152 is shifted in the direction of the arrow 158 along the operating line the distance X relative to the remaining components 82′, 92′, 60′ to the closed state of FIG. 12. This brings faces 80a′, 80b′, respectively on the mold plate 92′ and molding block section 62′, into close abutting relationship to close the mold cavities 42′ simultaneously as the faces 80c′, 80d′, respectively on the mold section 60′ and mold plate 90′, are brought into close abutting relationship to form the mold cavities 40′. The mold 38′ is changed back into the open state by moving the unit 152 oppositely to the direction of the arrow 158, as indicated by the arrow 158′ in FIG. 12, from the FIG. 12 position back into the FIG. 11 position.

It should be appreciated that for all of the disclosed embodiments there are many possible modifications within the general arrangement of components shown in FIG. 13. FIG. 13 schematically depicts a mold 38″, corresponding generally to the molds 38, 38′, and other variations depicted and otherwise devisable using the inventive concepts, and including first, second and third molding block sections 60″,62″,64″, corresponding generally to the molding block sections 60,62,64. The schematic representation is intended to encompass virtually an unlimited number of variations of the construction and relative movement of these basic components from those specifically shown and described herein, considered with the inventive concepts.

Additionally, it should be understood that the embodiments described herein may be utilized in a wide variety of extrusion blow molding machines having various shapes and orientations of molds.

1. An extrusion blow mold comprising:
a first molding block section having a first plurality of cavity portions;
a second molding block section having a second plurality of cavity portions; and
a third molding block section located between the first and second molding block sections, the third molding block section having:
a) a third plurality of cavity portions that are alignable one each with the cavity portions in the first plurality of cavity portions to thereby define a first plurality of cavities, each to receive a parison; and
b) a fourth plurality of cavity portions that are alignable one each with the cavity portions in the second plurality of cavity portions to thereby define a second plurality of cavities, each to receive a parison.

2. The extrusion blow mold of claim 1 wherein the first and third plurality of cavity portions are mirror images of one another and the second and fourth plurality of cavity portions are mirror images of one another.

3. The extrusion blow mold of claim 1 further comprising a rack and gear device having a rotating gear located on one of the molding block sections and a first toothed rack extending from another of the molding block sections and operably coupled to the rotating gear.

4. The extrusion blow mold of claim 3 further comprising a second toothed rack extending from a remaining molding block section and operably coupled to the rotating gear such that when the rotating gear rotates, the first and second molding block sections are brought towards or away from the third molding block section.

5. The extrusion blow mold of claim 1 further comprising a helical gear device having a first nut secured to one of the molding block sections, a bearing secured to another of the molding block sections and a helical gear extending between the first nut and the bearing.

6. The extrusion blow mold of claim 5 further comprising a second nut secured to a remaining molding block section wherein the helical gear extends between the first and second nuts through the bearing such that when the helical gear rotates, the first and second molding block sections are brought towards or away from the third molding block section.

7. The extrusion blow mold of claim 1 further comprising an harmonic arm device having a first arm secured to one of the molding block sections and a second arm secured to another of the molding block sections.

8. The extrusion blow mold of claim 7 further comprising a third arm secured to a remaining molding block section wherein the third arm is secured at a first end to the first arm and secured at a second end to the second arm such that as the third arm pivots, the first and second molding block sections are brought towards or away from the third molding block section.

9. The extrusion blow mold of claim 1 wherein the third molding block section is secured in a fixed position while the first and second molding block sections are movable towards and away from the third molding block section.

10. The extrusion blow mold of claim 1 wherein the third molding block section comprises first and second mold plates, and the extrusion blow mold is changeable between open and closed states by moving at least a part of the first molding block section and the first mold plate as a unit relative to the second molding block section and the second mold plate.

11. An extrusion blow molding machine comprising:
a first row of openings for extruding a first row of multiple parisons;
a second row of openings for extruding a second row of multiple parisons;
a mold having a length and including a first row of cavities extending along the length and a second row of cavities extending along the length adjacent the first row of cavities;
a first row of blow pins for cooperating with the first row of cavities to force the first row of parisons outwardly within the mold; and
a second row of blow pins for cooperating with the second row of cavities to force the second row of parisons outwardly within the mold.

12. The extrusion blow molding machine of claim 11 wherein the mold is defined by at least a first molding block section, a second molding section and a third molding block section.

13. The extrusion blow molding machine of claim 12 wherein the third molding block section is secured in a fixed position while the first and second molding block sections are movable towards and away from the third molding block section.

14. The extrusion blow molding machine of claim 12 further comprising a rack and gear device having a rotating gear located on one of the molding block sections and a first toothed rack extending from another of the molding block sections and operably coupled to the rotating gear.

15. The extrusion blow mold of claim 14 further comprising a second toothed rack extending from a remaining molding block section and operably coupled to the rotating gear such that when the rotating gear rotates, the first and second molding block sections are brought towards or away from the third molding block section.

16. The extrusion blow mold of claim 11 further comprising a helical gear device having a first nut secured to one of the molding block sections, a bearing secured to another of the molding block sections and a helical gear extending between the first nut and the bearing.

17. The extrusion blow mold of claim 16 further comprising a second nut secured to a remaining molding block section wherein the helical gear extends between the first and second nuts through the bearing such that when the helical gear rotates, the first and second molding block sections are brought towards or away from the third molding block section.

18. The extrusion blow mold of claim 11 further comprising an harmonic arm device having a first arm secured to one of the molding block sections and a second arm secured to the another of the molding block sections.

19. The extrusion blow mold of claim 18 further comprising a third arm secured to a remaining molding block section wherein the third arm is secured at a first end to the first arm and secured at a second end to the second arm such that as the third arm pivots, the first and second molding block sections are brought towards or away from the third molding block section.

20. The extrusion blow mold of claim 12 wherein the third molding block section comprises first and second mold plates, and the extrusion blow mold is changeable between open and closed states by moving at least a part of the first molding block section and the first mold plate as a unit relative to the second molding block section and the second mold plate.

21. A method for producing multiple rows of extruded blow molded products comprising the steps of:
extruding a first and a second row of multiple parisons;
receiving the first row of multiple parisons within a first row of mold cavities extending along a length in a mold;
receiving the second row of multiple parisons within a second row of mold cavities extending along the length in the mold adjacent the first row of cavities;
blowing a pressurized fluid within the first and second rows of multiple parisons to force the parisons outwardly within the first and second rows of mold cavities to form first and second rows of molded products; and
releasing the first and second rows of molded products from the first and second rows of mold cavities.
